(19) United States
(12) Patent Application Publication
(10) Pub. No.: US 2021/0362046 A1
(43) Pub. Date: Nov. 25, 2021

(54) Portable Multi-Player Smartphone Video Gaming System

(71) Applicant: Timothy James Farrell, JR., Hanson, MA (US)

(72) Inventor: Timothy James Farrell, JR., Hanson, MA (US)

(21) Appl. No.: 16/877,577

(22) Filed: May 19, 2020

(51) Int. Cl. A63F 13/26; A63F 13/23; A63F 13/215; A63F 13/35

(52) U.S. Cl. CPC A63F 13/26; A63F 13/23; A63F 13/215; A63F 2300/403; A63F 2300/1025; A63F 2300/1081; A63F 2300/301; A63F 13/35

(57) ABSTRACT

A multi-player smartphone video gaming system using a smartphone with a video game controller and a video game projector connected to an input-output port of the smartphone with wired connections. Earphones and a microphone are connected to an audio in/out port of the smartphone. A host server provides a multi-player video game playing application and video games for the smartphone through an Internet interface on the smartphone. The host server provides a platform for multi-player video gaming over the Internet through the internet interface of the smartphone. The smartphone, controller, and video game projector occupy less than 0.5 cubic feet of space. The projected video game display can be displayed up to 170 inches wide.

### FIELD OF THE INVENTION

This invention relates to systems and methods for multi-player video gaming and, more particularly, to a portable multi-player video gaming system that operates through a smartphone.

### BACKGROUND OF THE INVENTION

In the past, video game applications were executed and played using a personal computer or a game console attached to a television. A user purchased or rented a game, loaded the game onto the personal computer or inserted the game into the game console, and then played the game by methods well known in the art.

Currently, video games may be played over a network such as the Internet. The game is loaded onto a user's device, such as a game console, while other software needed to play the game resides on a server that is accessed via the network. Online gaming allows multiple users to compete against each other in the game environment provided by the software on the server.

The games played on game consoles may be played in a multi-player mode or a single-player mode. In a multi-player mode, a group of players connect over a network to participate in a single video game. While playing the game, each of the groups of players may operate individual handheld controllers to control their respective characters. The groups of players may play the game while being in close proximity with each other or may play the game while being located at geographically distant locations. Each of the players may belong to either a same team or different teams when involved in team play.

A mobile device such as a smartphone may provide a video game to a user that can be controlled through the touchscreen controls of the mobile phone. These controls are virtually created and displayed on the touchscreen. Because such mobile phones are not manufactured specifically for gaming, the processing power of such mobile phones has been often too low for many games. Another problem with mobile phones is that they are often unable to support certain games because such games require a certain operating system environment to run. Further, the virtual buttons take up valuable screen space thereby reducing the overall display of the game to the user. Virtual control buttons simulated through the touchscreen of the display provide a poor interface between the user and the game. It is difficult to gain a tactile interaction with a virtual button since the button is virtualized on a flat screen. Without a tactile reference, the only way to ensure that the virtual button is being engaged is to physically look at the finger and the virtual button simultaneously. This may take the eye of the gamer away from the screen at a crucial point in a game. Also, the buttons are limited to the front surface of the mobile device. Since the buttons are virtually created, these buttons can only be presented on the touch screen display. Competition for screen space may cause the number of buttons to be reduced, or to be rendered so small that they are difficult to use.

5G (fifth generation) smartphones have greater bandwidth, giving faster download speeds, eventually up to 10 gigabits per second (Gbps), compared to 4G smartphones. Due to the increased bandwidth, it is expected that new networks will not just serve smartphones like existing cellular networks, but also be used as general internet service providers for laptops and desktop computers, competing with existing internet service providers such as cable internet, and also will make possible new applications in the Internet of Things and Machine to Machine areas. In 5G, the “air latency” in equipment is 8-12 milliseconds. Verizon reports the latency on its 5G early deployment is 30 ms and Edge Servers close to the towers can reduce latency to 10-20 ms.

Games have become increasingly advanced with higher resolution graphics demanding increasing advanced hardware. Conventional gaming systems involve a game console that is connected to a television for outputting video from the game and one or more controllers connected the game console. This equipment is expensive and a large screen television is inconvenient to move from one place to another.

Smartphones can eliminate the need for a console and a monitor or television, but the display is too small. U.S. Pat. No. 8,175,639 discloses a mobile phone with a projector but there is no suggestion that the projector is suitable for video game playing. The display is limited to a useful range of about 17 inches. Controllers are known for use with smartphones, but a television or other suitable monitor is required for acceptable video game display. What is needed is a projection system for a smartphone that will project a large display, for example 32 inches or greater.

### SUMMARY OF THE INVENTION

The present invention is a multi-player smartphone video gaming system having a smartphone with a processor, a memory, an audio in/out port, an input-output port for charging the smartphone and connecting the smart phone to other devices, a network interface for connecting to the internet or a local area network, and a power supply. A video game controller is connected to the input-output port and a video game projector is also connected to the input-output port. The video game controller and the video game projector are wire connected to the input-output port to prevent unwanted latency. Earphones and a microphone are connected to the audio in/out port.

A host server provides a multi-player video game playing application and video games for the smartphone through the network interface. The host server also provides a platform for multiplayer video gaming over a network through the network interface of the smartphone. The video game projector produces a display onto a surface of a video game that is on the smartphone, through a lens in the video game projector. The surface is, preferably, 5 to 16 feet from the video game projector and the video game display is adjustable up to 170 inches in width.

A plurality of multi-player video gaming systems can be used with a video game display from a single video game projector. The smartphone and the video game controller can receive power from the video game projector. The smartphone, controller, and video game projector occupy less than 0.5 cubic feet of space and weigh less than five pounds.

An advantage of the present invention is a multi-player video gaming system that is compact and light weight.

Another advantage is a multi-player video gaming system that uses a video game projector in combination with the smartphone to produce a video game display up to 170 inches wide on a surface, such as a wall.

Another advantage is a multi-player video gaming system that allows multiple video game players to play a video game on their smartphones over the Internet using a single video game display projected on the surface of a wall.

Another advantage is that the Internet access can be WIFI or cellular.

Another advantage is the ability to have the smartphone and the video game controller powered by the video game projector.

Another advantage is the ability of the video game players to speak with each other and to view each other.

### BRIEF DESCRIPTION OF THE DRAWINGS

FIG. 1 is a front, perspective illustration of the smartphone video gaming system of this invention, showing a smartphone, a video-game controller, and a video game projector.

FIG. 2 is a right-side elevation view of the video game projector showing audio, video, and USB input ports.

FIG. 3 is an illustration of a plurality of smartphone video game systems in front of a projected video game display on a surface for single video game play.

FIG. 4 is a block diagram illustrating a network environment for multi-player video gaming, in accordance with an embodiment of the smartphone video gaming system.

FIG. 5 is a block diagram illustrating an exemplary computing device, in accordance with embodiments of the disclosure.

### DETAILED DESCRIPTION OF THE INVENTION

While the following description details the preferred embodiments of the present invention, it is to be understood that the invention is not limited in its application to the details of arrangement of the parts or steps of the methods illustrated in the accompanying figures, since the invention is capable of other embodiments and of being practiced in various ways.

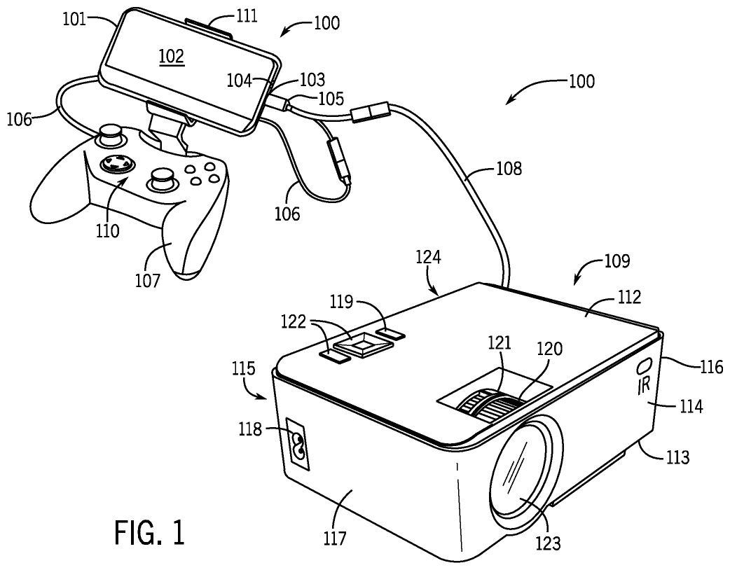

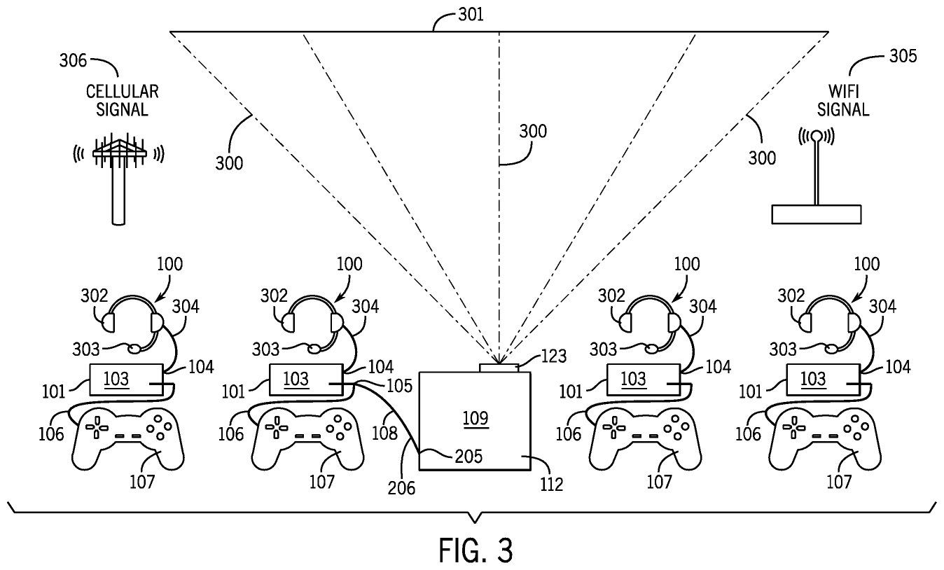

FIG. 1 shows a front, perspective illustration of the smartphone video gaming system 100 of this invention, showing a smartphone 101 with a display screen 102, an input-output port 103, and an audio in/out port 104 for attaching earphones 302 and a microphone 303 (see FIG. 3). An input-output splitter connector 105 is attached to the input-output port 103 of the smartphone 101.

One cable 106 from the splitter connector 105 is connected to a video-game controller 107 and another cable 108 from the splitter connector 105 is connected to a video game projector 109. The splitter 105 may have additional cables. The video game controller 107 has a plurality of video gaming controls 110 well known in the art. The video game controller 107 also has a support member 111 for holding the smartphone 101 in place on the video game controller 107. An example of a suitable video game controller is the Rotor Riot Wired Game Controller (https://www.apple.com/shop/product/HINEV2ZM/A/rotor-riot-wired-game-controller).

The video game projector 109 has a top surface 112, a bottom end 113, a front end 114, a rear end 115, a right side 116, and a left side 117. A power connector 118 is located on the left side 117. An on/off switch 119, a manual focus 120, a keystone 121, and programming buttons 122 are located on the top surface 112 of the video game projector 109. An adjustable lens 123 is located on the front end 114. An example of a suitable projector is the DBPower Projector (https://www.amazon.com/DBPOWER-Projector-Compatible-Smartphone-Brightness/dp/B07FKLN839/ref=dp_ob_title_ce).

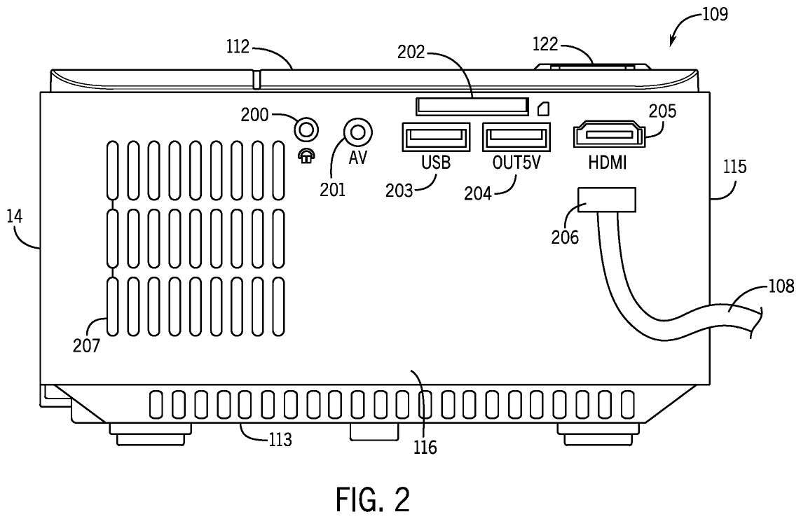

FIG. 2 shows a right-side elevation view of the video game projector 109. The video game projector 109 has several ports on the right side 116: an audio jack input 200, and A-V input 201, an SD card slot 202, a USB in 203, a USB out 204, and a HDMI input 205. An HDMI connector 206 is shown attached to an end of the video game projector cable 108. The smartphone 101 and the controller 107 may be powered by the video game projector 109.

FIG. 3 is an illustration of a plurality of smartphone video gaming systems 100 in front of a projected video game display 300 projected on a surface 301 from the video game projector 109 for single screen video game play. Also shown are headphones 302 and a microphone 303 connected to the audio in/out port 104 on the smartphone 101 by cable 304. If all video game players are in the same room, then only one smartphone video gaming system 100 needs to project the video game from the smartphone 101 onto the surface 301. Video game players in separate locations would use their own video game projectors 109 to project the same video game display 300. If video game players are engaged in multiple screen video game play, then each video game player would use his or her own video game projector 109 and would be located where the video game players cannot see each other's video game display 300. The smartphone 101 has access to the internet through a WIFI signal 305 or a Cellular signal 306 or both.

The smartphone video game system 100 is very compact. The video game projector may be 5.8×2.8×7.3 inches, the controller may be 2.0×6.0×4.75 inches, and the smartphone may be 50×2.3×0.3 inches. The video game projector may weigh 2.17 pounds, the controller may weigh 0.7 pounds, and the smartphone may weigh 0.25 pounds. The small sizes and weights make the smartphone video game system compact, readily portable and easy to carry.

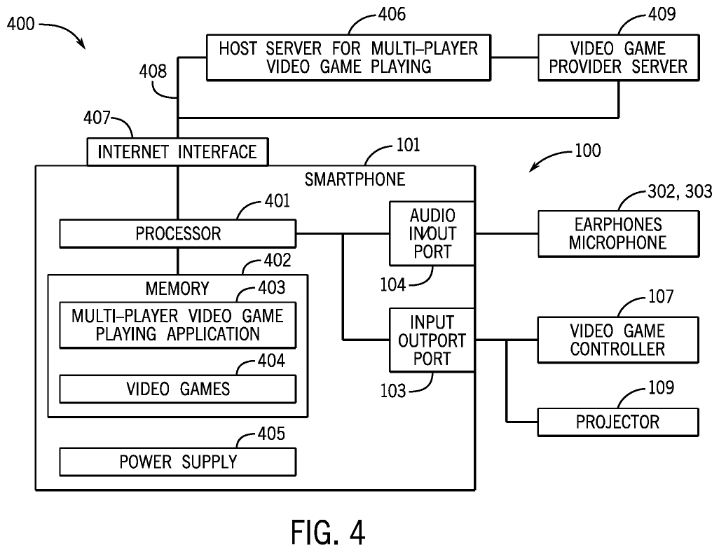

FIG. 4 is a block diagram illustrating a network environment 400 for multi-player video gaming, in accordance with an embodiment of the smartphone video gaming system 100. The smartphone 101 has a processor 401 communicatively connected to a memory 402, an internet communication interface 407, the audio in/out port 104 communicatively connected to earphones 302 and a microphone 303, and to the input-output port 103 communicatively connected to the video game controller 107 and the video game projector 109. The memory 402 includes a multi-player video game playing application 403 and may also include one or more video games 404. The smartphone 101 has a power supply 405, such as a rechargeable battery which can be charged through the input-output port 103. The smartphone 101 is connected to a host server 406 through the Internet interface 407 and the Internet 408.

The host server 406 provides the multi-player video game playing application 403 to a user's smartphone 101 through the Internet 408 and may also supply video games 404. The host server 406 and users may obtain video games 404 from a video game provider 409 through the internet 408.

The video game is played over a network such as the Internet. The game is loaded onto a user's smartphone while other software needed to play the game resides on a server that is accessed via the network. Online gaming allows multiple users to compete against each other in the game environment provided by the software on the server. The games played using the smartphone system 100 may be played in a multi-player mode or a single-player mode. In a multi-player mode, individual players or a group of players connect over a network to the host server 406 to participate in a single video game. While playing the game, each of the players operate the individual handheld controllers 107 to control their respective characters. The individual players or groups of players may play the game while being in close proximity with each other or may play the game while being located at geographically distant locations. The players may view a common video game display or view their own video game display privately.

The smartphone of this invention replaces a console, tablet, and personal computer for video game playing, including league, tournament, and competition video game playing. A smartphone is a handheld personal computer having features like those shown in FIG. 4. A smartphone possesses extensive computing capabilities, including high-speed access to the Internet using both Wi-Fi and mobile broadband. Most, if not all, smartphones are also built with support for Bluetooth wireless transmission and satellite navigation (GPS). Modern smartphones have a touchscreen color display with a graphical user interface that covers the front surface and enables a user to use a virtual keyboard to type and press onscreen icons. Interaction is mostly done using touch, besides a few physical buttons. Smartphones function using a rechargeable lithium-ion or lithium-polymer battery. Smartphones use a mobile operating system and can process a variety of software components, known as applications or “apps”. Most basic apps (e.g. event calendar, camera, web browser) come pre-installed with the system, while others are available for download. Apps, and the operating system in the smartphone, can receive additional functionality through updates. The smartphone video gaming system 100 improves the use of the smartphone by configuring the smartphone with wired connections to a controller and a video game projector. The wired connections prevent unwanted latency in communication and the video game projector produces a large display (32 to 170 inches wide) of the video game on any suitable surface.

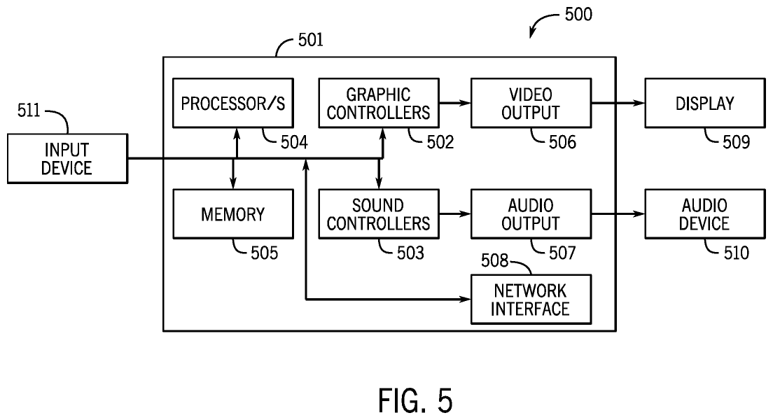

FIG. 5 is a block diagram illustrating an exemplary user computing device, in accordance with embodiments of the disclosure. All the blocks shown are implemented by suitable circuitry and may be implemented in hardware and/or software. A user device 500 has a computer system 501 with a graphics controller 502 and sound controllers 503. The graphics controller 502 and sound controller 503 are provided by the one or more processors 504 and memory 505. The graphics controller 502 is configured to provide a video output 506. The sound controller 503 is configured to provide an audio output 506. The computer system 501 has a network interface 508 allowing the computer system 501 to be able to communicate with a network such as the Internet or other communication infrastructure. The video output 506 is provided to a display 509. The audio output 507 is provided to an audio device 510 such as a speaker and/or earphone. The user device 500 has an input device 511 which can take any suitable format and can be one or more keyboards, audio input, mouse, touch screen, joystick, projector, or game controller. The user device 500 is shown by way of example only. In alternative embodiments, one or more of the parts may be omitted. Alternatively, or additionally, some embodiments may comprise one or more other parts. Alternatively, or additionally, one or more parts may be combined.

The foregoing description illustrates and describes the disclosure. Additionally, the disclosure shows and describes only the preferred embodiments but, as mentioned above, it is to be understood that the preferred embodiments are capable of being formed in various other combinations, modifications, and environments and are capable of changes or modifications within the scope of the invention concepts as expressed herein, commensurate with the above teachings and/or the skill or knowledge of the relevant art.

The embodiments described herein above are further intended to explain the best modes known by applicant and to enable others skilled in the art to utilize the disclosure in such, or other, embodiments and with the various modifications required by the particular applications or uses thereof. Accordingly, the description is not intended to limit the invention to the form disclosed herein. Also, it is intended that the appended claims be construed to include alternative embodiments. It will be further understood that various changes in the details, materials, and arrangements of the parts which have been described and illustrated above in order to explain the nature of this invention may be made by those skilled in the art without departing from the principle and scope of the invention as recited in the following claims.

1. A multi-player smartphone video gaming system, comprising:
a) a smartphone having a processor, a memory, an audio in/out port, an input-output port, a network interface, and a power supply;
b) a video game controller wire-connected to the input-output port;
c) a video game projector wire-connected to the input-output port; and
d) earphones and a microphone connected to the audio in/out port.

2. The multi-player smartphone video gaming system of claim 1 further comprising a host server that provides a multi-player video game playing application and video games for the smartphone through the network interface.

3. The multi-player smartphone video gaming system of claim 1 further comprising a host server providing a platform for multiplayer video gaming over a network through the network interface of the smartphone.

4. The multi-player smartphone video gaming system of claim 1, wherein the video game projector produces a video game display from a lens in the video game projector onto a surface, said surface being 5 to 16 feet from the video game projector and said video game display being adjustable up to 170 inches in width.

5. The multi-player smartphone video gaming system of claim 3, wherein a plurality of video gaming systems is used with a video game display from a single video game projector.

6. The multi-player smartphone video gaming system of claim 1 wherein the smartphone receives power from the video game projector.

7. The multi-player smartphone video gaming system of claim 1 wherein the smartphone, controller, and video game projector are constructed to occupy less than 0.5 cubic feet of space.

8. A multi-player smartphone video gaming system, comprising:
a) a smartphone having a processor, a memory, an audio in/out port, an input-output port, a network interface, and a power supply;
b) a video game controller wire-connected to the input-output port;
c) a video game projector wire-connected to the input-output port;
d) earphones and a microphone connected to the audio in/out port;
e) a host server that provides a multi-player video game playing application and video games for the smartphone through the network interface; and
f) the host server providing a platform for multiplayer video gaming over a network through the network interface of the smartphone.

9. The multi-player smartphone video gaming system of claim 8, wherein the video game projector produces a video game display from a lens in the video game projector onto a surface, said surface being 5 to 16 feet from the video game projector and said video game display being adjustable up to 170 inches in width.

10. The multi-player smartphone video gaming system of claim 8, wherein a plurality of video gaming systems is used with a video game display from a single video game projector.

11. The multi-player smartphone video gaming system of claim 8 wherein the smartphone receives power from the video game projector.

12. The multi-player smartphone video gaming system of claim 8 wherein the smartphone, controller, and video game projector are constructed to occupy less than 0.5 cubic feet of space.

13. A multi-player smartphone video gaming system, comprising:
a) a smartphone having a processor, a memory, an audio in/out port, an input-output port, a network interface, and a power supply;
b) a video game controller wire-connected to the input-output port;
c) a video game projector wire-connected to the input-output port;
d) earphones and a microphone connected to the audio in/out port;
e) a host server that provides a multi-player video game playing application and video games for the smartphone through the network interface; and
f) the host server providing a platform for multiplayer video gaming over a network through the network interface of the smartphone, wherein the video game projector produces a video game display from a lens in the video game projector onto a surface, said surface being 5 to 16 feet from the video game projector and said video game display being adjustable up to 170 inches in width and wherein a plurality of video gaming systems is used with a video game display from a single video game projector.

14. The multi-player smartphone video gaming system of claim 13 wherein the smartphone receives power from the video game projector.

15. The multi-player smartphone video gaming system of claim 14 wherein the smartphone, controller, and video game projector are constructed to occupy less than 0.5 cubic feet of space and to weigh less than 5 pounds.

16. A multi-player smartphone video gaming system, comprising:
a) a smartphone having a processor, a memory, an audio in/out port, an input-output port, a network interface, and a power supply;
b) a video game controller connected to the smartphone;
c) a video game projector connected to the smartphone; and
d) earphones and a microphone connected to the audio in/out port.

17. The multi-player smartphone video gaming system of claim 16 further comprising a host server that provides a multi-player video game playing application, video games for the smartphone through the network interface, and a platform for multiplayer video gaming over a network through the network interface of the smartphone.

18. The multi-player smartphone video gaming system of claim 17, wherein the video game projector produces a video game display from a lens in the video game projector onto a surface, said surface being 5 to 16 feet from the video game projector and said video game display being adjustable up to 170 inches in width and wherein a plurality of video gaming systems is used with a video game display from a single video game projector.

19. The multi-player smartphone video gaming system of claim 18 wherein the smartphone receives power from the video game projector.

20. The multi-player smartphone video gaming system of claim 19 wherein the smartphone, controller, and video game projector are constructed to occupy less than 0.5 cubic feet of space.
